(19) United States
(12) Patent Application Publication
(10) Pub. No.: US 2019/0303852 A1
(43) Pub. Date: Oct. 3, 2019

(54) PERISHABLE PRODUCT INFORMATION COORDINATION SYSTEM FOR A CARGO TRANSPORT SYSTEM

(71) Applicant: Carrier Corporation, Palm Beach Gardens, FL (US)

(72) Inventors: Robert A. Chopko, Baldwinsville, NY (US); Marc Beasley, Beverly, MA (US); Ciara Poolman, Syracuse, NY (US)

(21) Appl. No.: 16/315,847

(22) PCT Filed: Jul. 6, 2017
(86) PCT No.: PCT/US2017/040878

§ 371 Date: Jan. 7, 2019

Related U.S. Application Data
(60) Provisional application No. 62/359,438, filed on Jul. 7, 2016.

(51) Int. Cl. G06Q 10/08

(52) U.S. Cl. CPC G06Q 10/0832; G06Q 10/0833

(57) ABSTRACT

A computer implemented method of operating an information coordination system of a cargo transport system includes entering a proposed delivery task into a remote user interface device. An environmental control assembly of a cargo transport system may be utilized to monitor a product for a specified condition. Condition updates associated with the monitoring may be sent to the remote user interface.

### BACKGROUND

The present disclosure relates to a cargo transport system, and more particularly, to a perishable product information coordination system of the cargo transport system.

Traditional cargo transport systems may monitor and collect environment parameter data such as temperature, humidity and ethylene concentrations during refrigerated transportation. The collected parameter data may be used to infer a condition of the perishable product in a very general manner. Typically, conclusions drawn from such data is speculative, and regardless of the data the product may have suffered due to sub-optimal environmental parameters. Moreover, the dispersion and archiving of transport and product condition data before, during, and after transport may be limited leading to lost opportunity to optimize the transport process. Improvements in the transportation and/or storage of perishable products is desirable.

### SUMMARY

A computer implemented method of operating an information coordination system of a cargo transport system according to one, non-limiting, embodiment of the present disclosure includes entering a proposed delivery task into a first remote user interface device; monitoring a product for a specified condition utilizing an environmental control assembly of the cargo transport system; and sending condition updates associated with the monitoring to the first remote user interface.

Additionally to the foregoing embodiment, the method includes evaluating the proposed delivery task by an analysis module for acceptance or rejection.

In the alternative or additionally thereto, in the foregoing embodiment, at least one of product type data, customer data, time in transport data, initial product condition data and arriving product condition data is applied to evaluate the proposed delivery task.

In the alternative or additionally thereto, in the foregoing embodiment, the method includes controlling the environmental control assembly via the first remote user interface device.

In the alternative or additionally thereto, in the foregoing embodiment, the method includes archiving the monitored product condition data by the information coordination system.

In the alternative or additionally thereto, in the foregoing embodiment, the method includes inputting customer feedback data into a database via a second remote user interface device.

An information coordination system of a cargo transport system according to another, non-limiting, embodiment includes an analysis module configured to communicate with the cargo transport system; a first remote user interface configured to communicate with the analysis module; and a destination database configured to receive destination data from the first remote user interface and provide the data to the analysis module for execution.

Additionally to the foregoing embodiment, the data includes a product destination.

In the alternative or additionally thereto, in the foregoing embodiment, the information coordination system includes a sensor data database configured to receive sensor data from the cargo transport system; and a reporting module configured to communicate with the first remote user interface for providing at least a product condition update of a product in transport and associated with the sensor data.

In the alternative or additionally thereto, in the foregoing embodiment, the information coordination system includes a second remote user interface configured to send customer feedback data to the reporting module.

In the alternative or additionally thereto, in the foregoing embodiment, the customer feedback data is stored in the destination database.

In the alternative or additionally thereto, in the foregoing embodiment, the analysis module is configured to execute an algorithm utilizing at least the destination data and the sensor data to determine a predicted product condition upon arrival.

In the alternative or additionally thereto, in the foregoing embodiment, the destination data includes a destination and a desired product condition upon arrival.

In the alternative or additionally thereto, in the foregoing embodiment, the product is produce and the product condition is ripeness.

In the alternative or additionally thereto, in the foregoing embodiment, the product condition is best fit for market consumption.

In the alternative or additionally thereto, in the foregoing embodiment, the destination data includes an initial condition.

In the alternative or additionally thereto, in the foregoing embodiment, the desired product condition is associated with a specific customer stored as data in the destination database.

In the alternative or additionally thereto, in the foregoing embodiment, the analysis module is configured to output a command signal to the cargo transport system to control the product condition.

In the alternative or additionally thereto, in the foregoing embodiment, the first remote user interface is wireless.

In the alternative or additionally thereto, in the foregoing embodiment, the analysis module includes a satellite navigation system receiver circuit for determining current location of the product during transport.

The foregoing features and elements may be combined in various combinations without exclusivity, unless expressly indicated otherwise. These features and elements as well as the operation thereof will become more apparent in light of the following description and the accompanying drawings. However, it should be understood that the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiments. The drawings that accompany the detailed description can be briefly described as follows:

FIG. 1 is a side view of a tractor trailer system as one, non-limiting, application of a cargo transport system of the present disclosure;

FIG. 2 is a schematic of the cargo transport system;

FIG. 3 is a schematic of a product condition system of the cargo transport system;

FIG. 4 is a perspective view of a detector of the cargo transport system secured to a perishable product;

FIG. 5 is a pre-programmed product type table of the product condition system;

FIG. 6 is a second tier of the product type table;

FIG. 7 is a flow chart of a method of operating the product condition system;

FIG. 8 is a schematic of the product condition system illustrated a plurality of ad hoc networked detectors;

FIG. 9 is a schematic of the networked detector;

FIG. 10 is a flowchart generally associated with handshake software of each detector;

FIG. 11 is a flowchart generally associated with the coordination of base software of each detector;

FIG. 13 is a flowchart generally associated with alert software of each detector;

FIG. 14 is a table illustrating one example of an alert database of each detector;

FIG. 15 is a schematic of an information coordination system of product condition system;

FIG. 16 is a schematic of a reporting module of the information coordination system; and

FIG. 17 is a flowchart of a method of method of operating the information coordination system.

### DETAILED DESCRIPTION

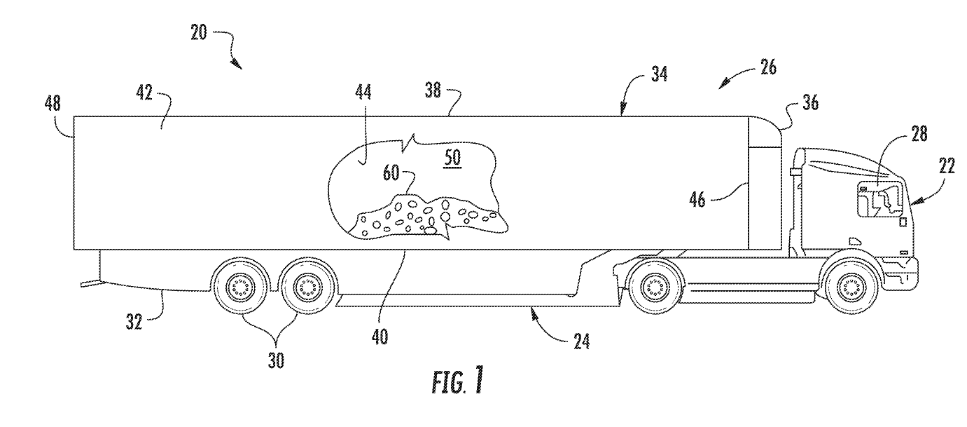

Referring to FIG. 1, one, non-limiting, application for a transport containment assembly of the present disclosure is illustrated as a tractor trailer system 20. The tractor trailer system 20 may include a tractor 22, a trailer 24 and a cargo transport system 26 utilized to control environmental parameters. The tractor 22 may include an operator's compartment or cab 28 and an engine (not shown) which is part of the powertrain or drive system of the tractor 22. The trailer 24 may include a plurality of wheels 30 rotationally engaged to a frame or platform 32 that may be detachably coupled to the tractor 22. The frame 32 is constructed to support the cargo transport system 26 for ground transport to desired destinations. The cargo transport system 26, at least in-part, may be an integral part of the frame 32, or, may be constructed for removal from the frame. It is contemplated and understood that the transport containment assembly 26 may be constructed for other types of transportation other than tractor trailer systems and/or may be adapted for use in multiple types of transportation (e.g., ground, sea, and/or air).

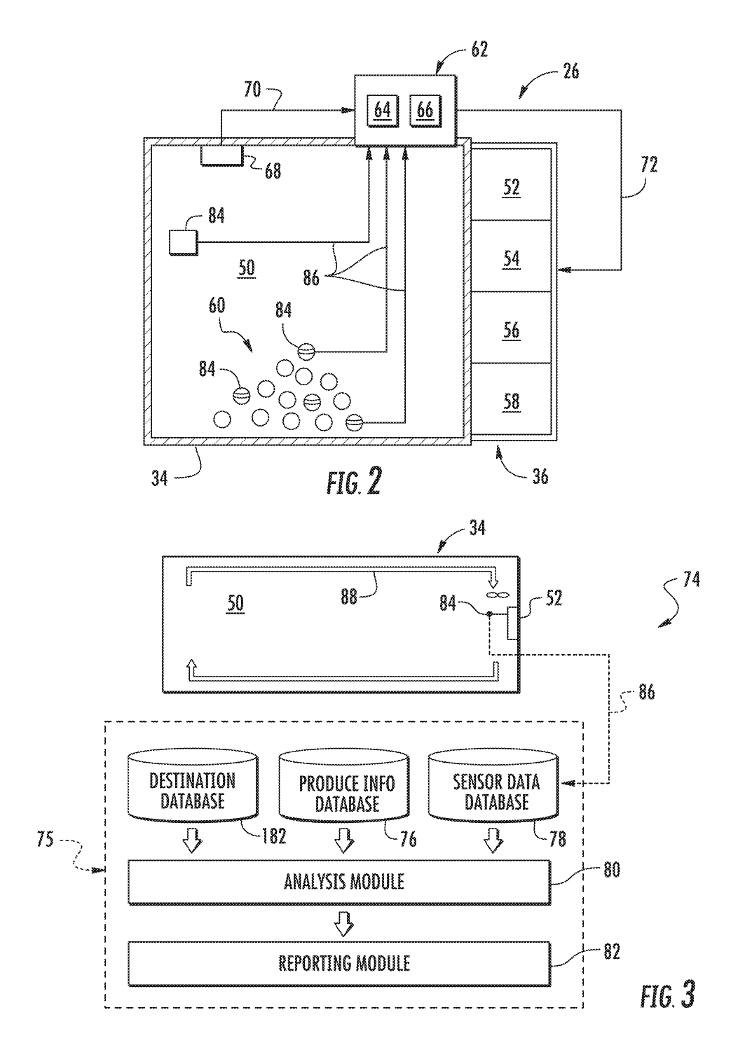

Referring to FIGS. 1 and 2, the cargo transport system 26 may include a container 34, an environmental control assembly 36, and a perishable product condition system 74. The container 34 may include top, bottom, two sides, front and rear walls 38, 40, 42, 44, 46, 48 (also see FIG. 2) that together define the boundaries of a cargo compartment or space 50. The environmental control assembly 36 may be an integral part of the container 34 and may be located at or near the front wall 46. The environmental control assembly 36 facilitates the control of environmental parameters within the cargo compartment 50. The container 34 may further include doors (not shown) at the rear wall 48, or any other wall. It is contemplated and understood that the container 34 may be any shape and, in some applications, may not be completely enclosed (e.g., no top wall 38 and/or no side walls 42, 44, etc.).

Depending upon the environment parameter being controlled, the environmental control assembly 36 may include a refrigeration unit 52, a humidity control unit 54, an air exchange unit 56, and an environment composition control unit 58. Although illustrated separately, it is understood that any two or more of the units 52, 54, 56, 58 may generally be integrated together thereby sharing various components to achieve an end goal of controlling one or more environment parameters. For example, an environment parameter may be temperature controlled by the refrigeration unit 52. An environment parameter may be humidity controlled by the humidity control unit 54. However and depending upon outside conditions, the humidity and/or temperature may be controlled by the exchange of air accomplished via the air exchange unit 56. Another environment parameter may be a molecular composition of the air in the compartment 50. If the detected air composition is undesirable, it may be resolved via the environment composition control unit 58 that may, as one example, include a series of bottles containing one or more compressed gasses that can be injected into the compartment 50. Depending upon the cargo or product 60, the compressed gas may be an inert gas. Other examples of environment parameters that may be controlled include oxygen concentration, carbon dioxide concentration, ethylene concentration, ozone and 1-methylcyclopropene.

A control module 62 of the environmental control assembly 36 is configured to control any one or more of the units 52, 54, 56, 58, and may include a computer-based processor 64, a computer readable and writeable storage medium 66 and at least one of any variety of environment parameter detectors 68 as dictated by the needs and control of the various units 52, 54, 56, 58. The environment parameter detector 68 may be configured to monitor and/or measure at least one environment parameter and output an associated signal (see arrow 70) to the control module 62. The processor 64 of the control module 62 may be configured to process the signal 70 and send an associated command signal (see arrow 72) to any one or more of the units 52, 54, 56, 58 to control and maintain any variety of environment parameters.

The environment parameter detector 68 may be located in the containment 50 for generally measuring the environment parameter of the air in the containment which generally surrounds the product 60. The environment parameter may be dependent upon the product 60 being stored and/or transported, and may generally dictate the type of environment parameter detector 68 utilized. For example, the environment parameter detector 68 may be any one or more of a humidity sensor, a chemical sensor, a temperature sensor, oxygen sensor, carbon dioxide sensor, light sensor, ethylene sensor, ozone sensor, and others. More specifically, if the environment parameter is temperature, then the environment parameter detector 68 may be a temperature sensor. If the environment parameter is molecular composition, then the environment parameter detector 68 may be a chemical sensor, and if the environment parameter is humidity, then the environment parameter detector 68 may be a humidity sensor. The environment signal 70 generated by the environment parameter detector 68 may be transmitted over a wired or wireless pathway. For example, if the control module 62 is secured to the container 34 (i.e., travels with the container), the environment parameter detector 68 may utilize a wired pathway. If the control module 62 is remotely located (e.g., in the cab 28 or otherwise at a land-based location), the environment detector may utilize a wireless pathway.

Monitoring and/or Preserving Perishable Products

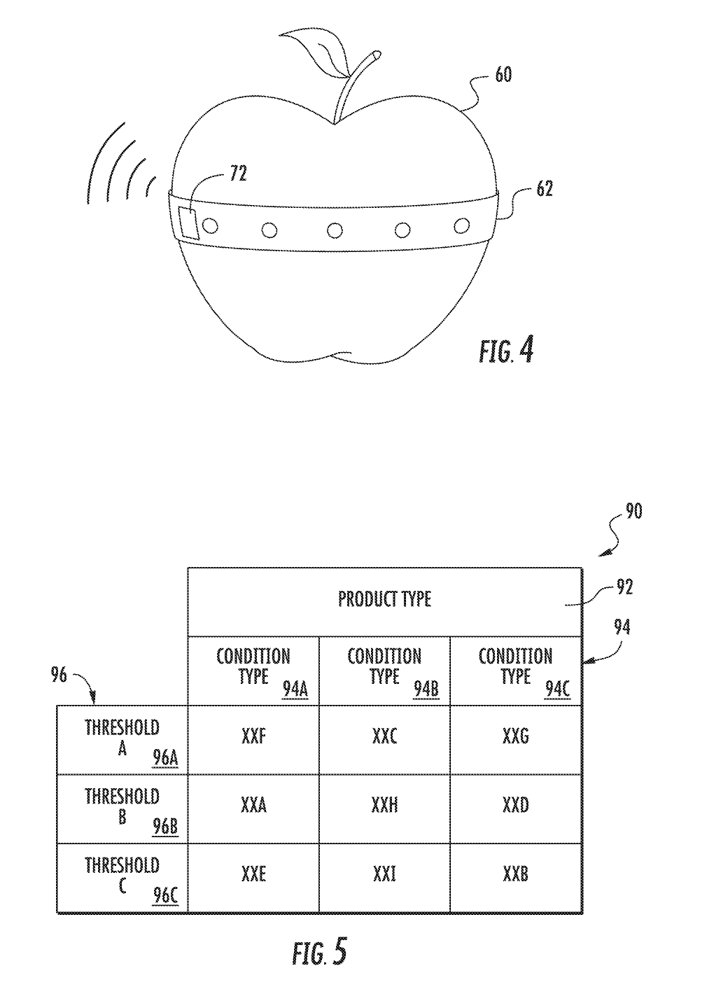

Referring to FIGS. 2 and 3, the product 60 may be a perishable product availing itself of a product condition system 74 (see FIG. 4) of the cargo transport system 26. The product condition system 74 may be adapted to monitor the perishable product 60, preserve the perishable product, and/or report out what may be a real-time condition of the perishable product. The product condition system 74 may include an information coordination system 75 that may include a pre-programmed product information database 76, a detector data database 78, an analysis module 80, and a reporting module 82. The product condition system 74 may further include at least one product condition detector 84 configured to transmit/send product condition data to the information coordination system 75. The information coordination system 75 of the product condition system 74 may be substantially software-based and programmed into, for example, the control module 62. More specifically, the pre-programmed product information database 76 and the detector data database 78 may be stored in the computer readable and writeable storage medium 66, the analysis module 80 may be part of the processor 64, and the reporting module 82 may include information outputted by the processor 64 (i.e., via processing of a condition signal 86 received by the condition detector 84), and stored in the medium 66 for later retrieval by a user. In addition to, or alternatively, the reporting module 82 may be configured to, at least in-part, send a command signal to any one of the units 52, 54, 56, 58 to alter an environment parameter to minimize or prevent degradation of the perishable product 60. It is further contemplated and understood that the product condition detector 84 may be the environment parameter detector 68, thus the detector may serve a dual purpose of providing data to the product condition system 74 indicative of a condition of the perishable product 60 and to generally monitor and control an associated environment parameter in the containment 50. It is further contemplated that the product condition system 74 may include a processor and computer readable and writeable storage medium that is separate from the control module 62, and instead, is configured to communicate with the control module 62 via, for example, the reporting module 82. The perishable product 60 may be anything capable of degrading during storage and/or transport including vegetables, fruits, meats, flowers, and other edible and non-edible products.

As illustrated in FIG. 3, the condition detector 84 may be, for example, a gas detector disposed in a supply duct 88 to the refrigeration unit 52 of the environmental control assembly 36. The product condition system 74 may be configured to monitor the levels of ethylene and alert the refrigeration unit 52 to take corrective action when a pre-programmed ethylene threshold value is reached that may indicate, for example, excessive ripening as one example of a product condition. Such action may be to decrease temperatures in the containment 50 as measured by the environment parameter detector 68. It is further contemplated and understood that, for example, the temperature in the containment may be monitored, via the environment parameter detector 68, and sent to the product condition system 74 for later reports, thus providing a time-based recording of both containment temperature and ethylene levels.

In one example, the perishable product 60 may be apples. Environment parameters that may be controlled to preserve apples may include humidity, temperature, light intensity, ethylene, ethanol, and acetaldehyde levels. To preserve apples and delay the ripening process, the containment 50 may be kept at low oxygen levels of about one percent, at carbon dioxide levels of between one and five percent, at low temperatures of about zero degrees centigrade, at high humidity of about ninety to ninety-five percent, and/or at an ethylene concentration range of about one to four-hundred parts per million.

In another example, the ripeness of a banana may be controlled by controlling the temperature within the containment 50, and by controlling the airflow (i.e., air exchange) to regulate the amount of carbon dioxide and ethylene present in the containment air. The degree of ripeness may be determined and recorded by measuring the concentration of the gasses produced by the banana and found in the containment air. In this example, data from the environment parameter detector 68 may be used and applied by the analysis module 80 supported by the processor 64 then appropriately adjusted and controlled via the environmental control assembly 36 as dictated by the command signal 72 of the control module 62.

In alternative embodiments, the condition detector 84 may be a plurality of detectors with at least one detector being proximate to a respective storage crate of a plurality of crates (not shown) stored in the containment 50. Each crate may contain a different type of perishable product 60. In yet another embodiment (see FIG. 4), the condition detector may be secured directly to what may be a random selection of a perishable product 60 (e.g., random selection of apples each associated with a detector). The condition detector(s) 84 may be attached directly to the perishable products to make direct, objective measurements of key condition attributes. Such measurements may include as non-limiting examples: color, firmness, and compositional changes, and/or emitted gases via respiration. Detector types may include imaging (i.e., camera), color, firmness, temperature, chemical, and others. For example, if the product condition of concern is firmness, the condition detector 84 may be a type of thin-film strain gauge that may further be part of a resiliently stretchable band that wraps about the perishable product 60. Another example of a condition detector 84 may include a radio frequency identification tag (RFID) with onboard gas sensing capability. Other examples of perishable products may include meats, and other examples of product condition may generally include ‘best fit for market consumption.’

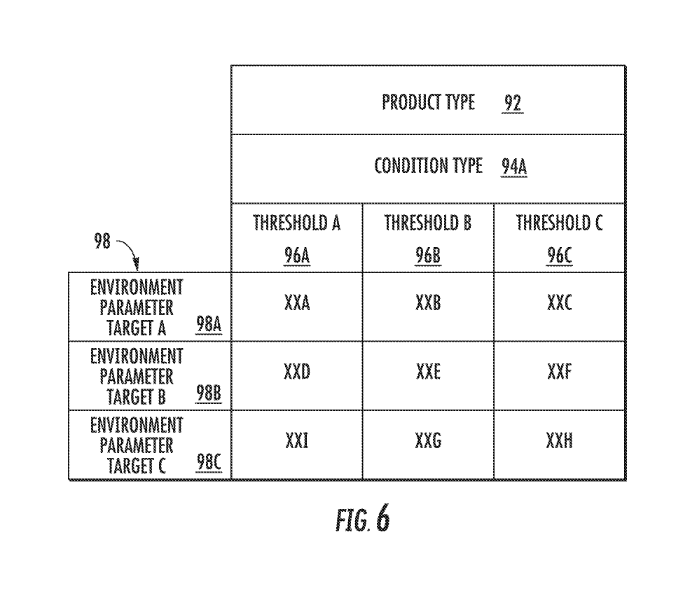

Referring to FIG. 5, the product information database 76 may include a plurality of tables 90 with each table being pre-programmed and specific to a type 92 of the perishable product 60. For the product type 92, the table 90 may include at least one product condition type 94 (i.e. three illustrated as 94A, 94B, and 94C). Non-limiting examples of condition types 94 may include color, firmness, gas concentration, and others. For each condition type 94, the product information database 76 may store at least one threshold value or range 96 (i.e. three illustrated as 96A, 96B, and 96C), pre-established to enact a specific action such as for example, transmit an alert to a user via the reporting module 82, and/or take a corrective action that may include initiation of the environmental control assembly 36. It is further contemplated and understood that a particular table 90 may be pre-selected by a user via a user interface (not shown) that communicates with the product condition system 74 once the user knows the type of product being stored and/or transported. Furthermore, the system 74 may be configured to know which type(s) of condition detectors 84 are available or pre-configured with a particular container 34, and thereby, automatically selects the correlating condition type 94 associated with the type of detector.

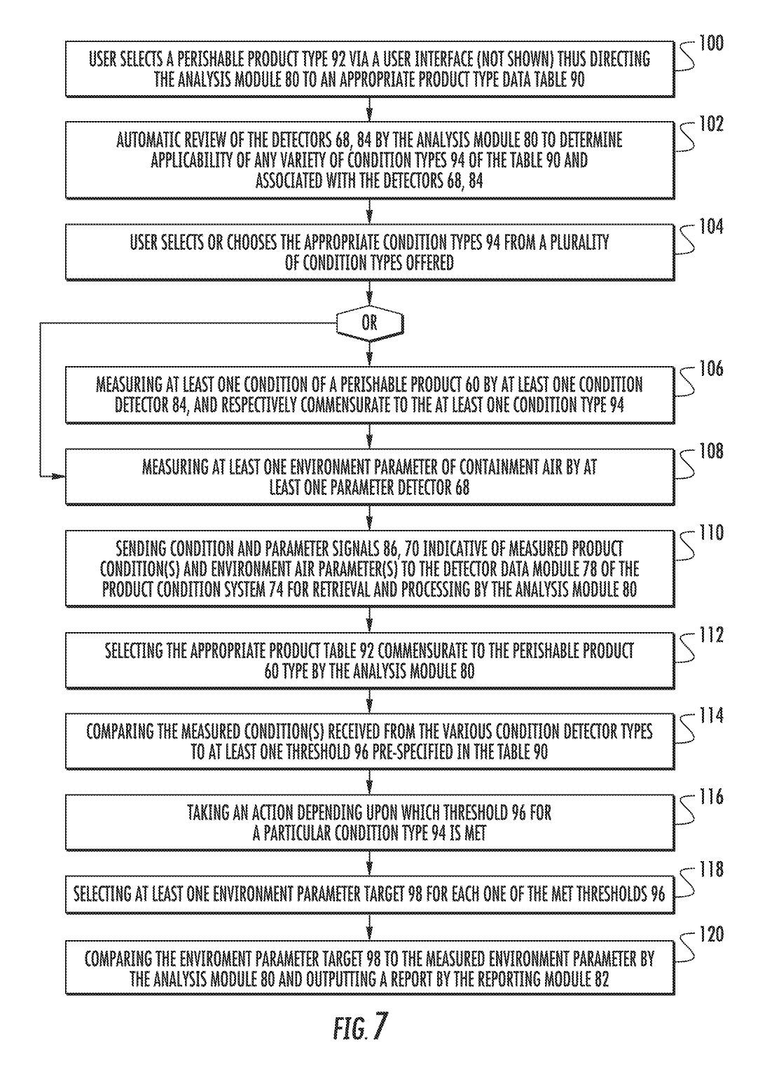

Referring to FIGS. 5 and 6, each table of a particular product type 92 and a particular condition type 94 may include at least one environment parameter target 98 (i.e. three illustrated as targets 98A, 98B, 98C). Environmental parameter targets 98 may be a desired value and/or a desired range of values that are preferred in order to preserve a perishable product and/or inhibit degradation (or further degradation) of a perishable product 60. What the environment parameter target 98 is may be dependent on the particular thresholds 96A, 96B, 96C that may be representative of the condition of the particular product type 92 of the perishable product 60. Examples of environment parameter targets 98 may include containment temperature, humidity, gas concentrations, rate of air exchanges, and others.

Referring to FIGS. 2-3 and 5-6, the storage medium 66 may: store algorithms executed by the analysis module 80 of the processor 64; may store detector 68, 84 data accumulated during storage and/or transit of the particular product 60; and may further store the data tables 92 specific to the type of product 60. For example, if the perishable product 60 is bananas, the ‘banana’ data table 90 may include desired environment parameter ranges or targets 98 needed to preserve and/or prevent the bananas from ripening or ripening too fast. Such data may include temperature, humidity, and the presence of certain gases (e.g., carbon dioxide and ethylene) which are produced during the ripening process.

Applying the relevant data tables 90, the analysis module 80 once receiving the parameter and/or condition signals 70, 86 (see FIGS. 2 and 3) may execute associated algorithms to first determine relevant and desired environment parameter target(s) 98, and may then generate appropriate command signals 72 that are sent to the environmental control assembly 36. The environmental control assembly 36 may then initiate the appropriate unit(s) 52, 54, 56, 58 to adjust the measured environment parameter of the containment air. It is contemplated and understood that the measured environment parameter and the measured product condition may be functions of the algorithm.

In another example, the measured product condition may be a function of the algorithm and the measured environment parameter is used to directly control the environmental control assembly 36. That is, combinations of ‘targeted’ environment parameters may be based on current conditions and needs of the perishable product 60 and would affect the product in various manners including slowing or accelerating ripening, inhibiting post-harvest plant pathogen growth, inhibiting water loss, inhibiting or promoting color change, and/or adjusting to changes in chilling sensitivity. It is understood that the term ‘targeted’ environment parameter is that parameter calculated by the control module 66 based on real-time conditions of the product 60. Via the command signal 72, it is the goal of the environmental control assembly 36 to adjust toward or obtain the parameter target or value 98. It is further contemplated and understood that this process may conserve energy since the environmental control assembly 36 may operate in real-time and consume energy only when needed (i.e., current needs).

Although not specifically illustrated in the data tables of FIGS. 5 and 6, it is further contemplated and understood that through executable algorithms, any one or more of the thresholds 96 may be dependent upon two or more condition types 94. Similarly, the environment parameter target 98 may be dependent upon two or more thresholds 96 of multiple condition types 94 and a particular product type 92. Although such calculations may require an increase in the number and diversity of detectors, by establishing a threshold 96 via of function of multiple condition types 94, and/or, establishing an environment parameter target 98 through a function of multiple thresholds 96 of different condition types 94, the reliability and accuracy of the product condition system 74 may be optimized.

Referring to FIG. 7, a method of operating the cargo transport system 26 includes a first block 100 of a user selecting a perishable product type 92 via a user interface (not shown) thus directing the analysis module 80 to an appropriate product type data table 90. Block 102 entails an automatic review of the detectors 68, 84 by the analysis module 80 to determine applicability of any variety of condition types 94 of the table 90 and associated with the detectors 68, 84. In addition to, or alternatively, to block 102, block 104 includes the user selecting or choosing the appropriate condition types 94 from a plurality of condition types offered.

Block 106 includes measuring at least one condition of a perishable product 60 by at least one condition detector 84, and respectively commensurate to the at least one condition type 94. A block 108 entails measuring at least one environment parameter of containment air by at least one environment parameter detector 68. Block 110 entails sending condition and parameter signals 86, 70 indicative of measured product condition(s) and environment air parameter(s) to the detector data database 78 of the product condition system 74 for retrieval and processing by the analysis module 80.

Block 112 entails selecting the appropriate product table 92 commensurate to the perishable product 60 type by the analysis module 80. Block 114 entails comparing the measured condition(s) received from the various condition detector types to at least one threshold 96 pre-specified in the table 90. Block 116 entails taking an action depending upon which threshold 96 for a particular condition type 94 is met.

For a particular product type 92 and a particular condition type 94, block 118 entails selecting at least one environment parameter target 98 for each one of the met thresholds 96. Block 120 entails comparing the environment parameter target 98 to the measured environment parameter by the analysis module 80 and outputting a report by the reporting module 82, wherein the report may be a command signal 72 to the appropriate/associated unit 52, 54, 56, 58 of the environmental control assembly 36 to reach the associated/respective target.

### Directly Networked Detectors

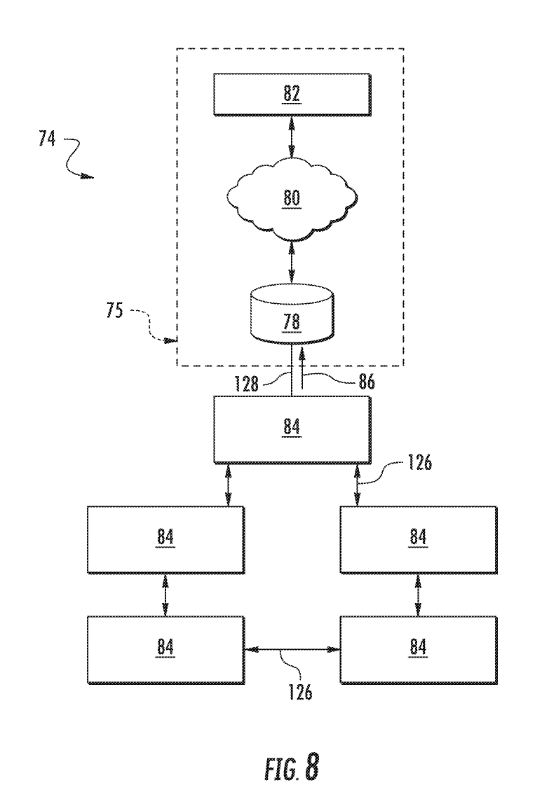

Referring to FIG. 8, the product condition system 74 may generally include or form an ad-hoc wireless mesh network generally implemented through software. That is, in an application using a plurality of condition detectors 84 (i.e., a network of detectors), the condition detectors 84 may communicate directly with one-another over pathways 126 that may be wireless. Each detector 84 performs some degree of processing and gathering of sensor data (e.g., product condition data). This communication between condition detectors 84 may be categorized and prioritized. The prioritized data may then be sent as a combined or multitude of condition signals (see arrow 86) to the information coordination system 75 over pathway 128 that may be wireless.

The detector data database 78 of the information coordination system 75 may be a cold chain mesh network gateway configured to transmit data (e.g., condition signal 86) out to the module 80 which may, for example, be the internet and/or a cloud server. From module 80, the data may be transmitted to the reporting module 82 of information coordination system 75 that may be at least one monitoring terminal. The information coordination system 75 may be configured to transmit commands and/or data to the detectors 84. In one embodiment, the information coordination system 75 may be remotely located from the networked detectors 84.

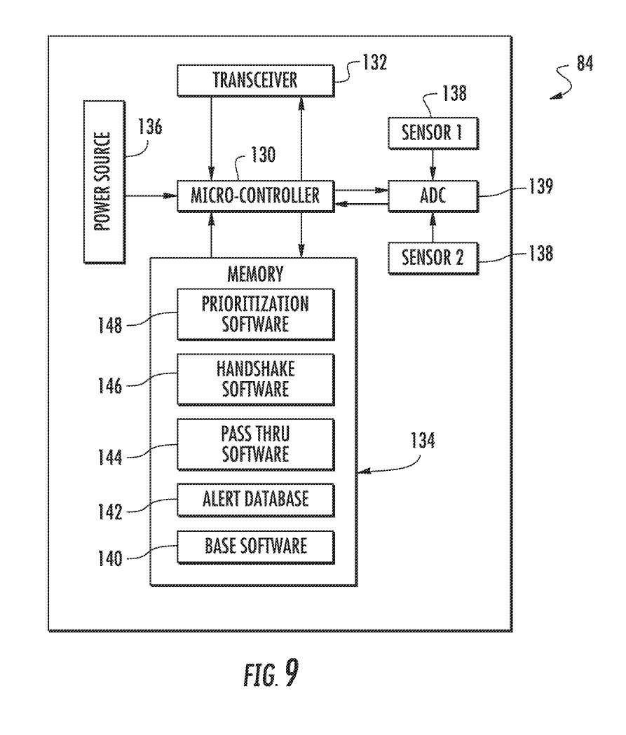

Referring to FIG. 9, to facilitate this ability, each detector 84 may include a processor or controller 130, a transceiver 132, a computer readable memory or medium 134, a power source 136 and at least one sensor 138 that may measure a condition of the product 60 and/or a parameter of, for example, containment air as previously described. The controller 130 may be a micro-controller, however, other alternatives may include digital signal processors, Field Programmable Gate Arrays (FPGAs) and Application Specific Integrated Circuits (ASICs). A microcontroller may be used in many embedded systems because of low cost, flexibility to connect to other devices, ease of programming, and low power consumption.

The detectors 84 (i.e., sensor nodes) may make use of Industrial, Scientific and Medical (ISM) band, which may provide free radio, spectrum allocation and global availability. Examples of wireless transmission media may include Radio Frequency (RF), optical communication (i.e., laser) and infrared. The transceiver 132 may combine the functionality of both a transmitter and a receiver. The operational states of the transceiver 132 may include transmit, receive, idle and sleep states. The transceiver 132 may further include a built-in state machine (not shown) that may perform some operation automatically. It is further contemplated and understood that the transceiver 132 may be configured to completely shut-down when not transmitting or receiving to, in some instances, conserve power.

The power source 136 of the detector 84 assures adequate energy needed to power the individual detectors for functions including sensing, communication, and data processing. The detectors 84 may be positioned in hard-to-reach locations making it impractical to run hard-wired power lines from a remote power source. Therefore, examples of a power source 136 may be a battery or a capacitor integrated into each individual detector 84. Examples of a battery 136 may include nickel-cadmium (NiCd), nickel-zinc (NiZn), nickel-metal hydride (NiMH), lithium-ion, and others which can meet the power demands of the detector for a pre-specified duration with the understanding that battery replacement or charging during storage and/or shipping of the product 60 may be impractical. Other power sources may include solar sources, temperature difference techniques, and/or vibration. The power source 136 may further include, or is configured with, a power saving policy that may be Dynamic Power Management (DPM) or Dynamic Voltage Scaling (DVS). DPM may conserve power by shutting down parts of the detector 84 that are not currently used or active. A DVS scheme may vary the power levels within the detector 84 depending on the non-deterministic workload. By varying the voltage along with the frequency, a quadratic reduction in power consumption may be obtained. Because the detector 84 may be a very small electronic device, the power source 136 may be somewhat limited, and for example, capable of delivering power at about 0.5 to 2.0 ampere-hour at 1.2 to 3.7 volts.

Each detector 84 may include at least one sensor 138 (i.e., two illustrated in FIG. 9). The sensors 138 are hardware devices that produce a measurable response to a change in a physical condition like, for example, temperature or pressure. The sensors 138 may measure physical data of a condition or parameter to be monitored. The continual analog signal produced by the sensors 138 may be digitized by an analog-to-digital converter (ADC) 139 and sent to controller 130 for further processing. The detector 84 and/or sensors 138 of the detector may be small in size, consume very low energy, operate in high volumetric densities, be autonomous and operate unattended, and be adaptive to the environment.

The sensors 138 may be classified into about three categories being: passive, omnidirectional sensors; passive, narrow-beam sensors; and active sensors. Passive sensors may sense the data without actually manipulating the environment by active probing. Passive sensors may be self-powered where energy is only needed to amplify their analog signal. Active sensors may actively probe the environment such as a sonar or radar sensor. Active sensors may require continuous energy from the power source 136. Narrow-beam sensors may have a well-defined notion of directional measurement (i.e., similar to a camera), and omnidirectional sensors may have no notion of direction involved in their measurements.

As previously described, the sensor 138 may be any variety of sensors capable of detecting the condition of the product 60. For example, the sensor may be an imaging sensor for detecting a change in color or shape. The sensor 138 may have direct contact with the product 60 and may be capable of detecting a degree of firmness. Alternatively, the sensor 138 may be any variety of sensors capable of measuring temperature, either of the product 60 itself and/or the surrounding environment air. Another example of a sensor may be a gas sensor configured to measure, for example, ethylene, emitted by the product 60 during ripening and/or degradation.

The computer readable medium 134 of the detector 84 may include base software 140, an alert database 142, pass-thru software 144, handshake software 146 and prioritization software 148. When new detectors 84 become part of the networked detectors 84, the handshake software 146 may acquire the sensor data and product data from the new detector, writes that information to an inventory database and shares back the inventory database with the new detector along with a priority table and prioritization software 148. Data packets may move through and/or amongst the networked detectors 84 using any variety of routing programs. In addition, when more than one data packet arrives at the same detector for re-transmission, the prioritization software 148 determines transmission order. For example, a data packet may include alerts, other data associated with the sensing/alerting detector, and condition data that may be within a certain range (e.g., twenty percent) of the sensing detector's alert threshold. In this example, the prioritization software may first transmit the alert, then the other data associated with the sensing detector, and then the condition data. After both of these scenarios are examined, order data is prioritized when the GPS data indicates the detector 84 is within one mile of its destination. After those question, if no criteria is met, data packet transmission is prioritized by the Priority Table.

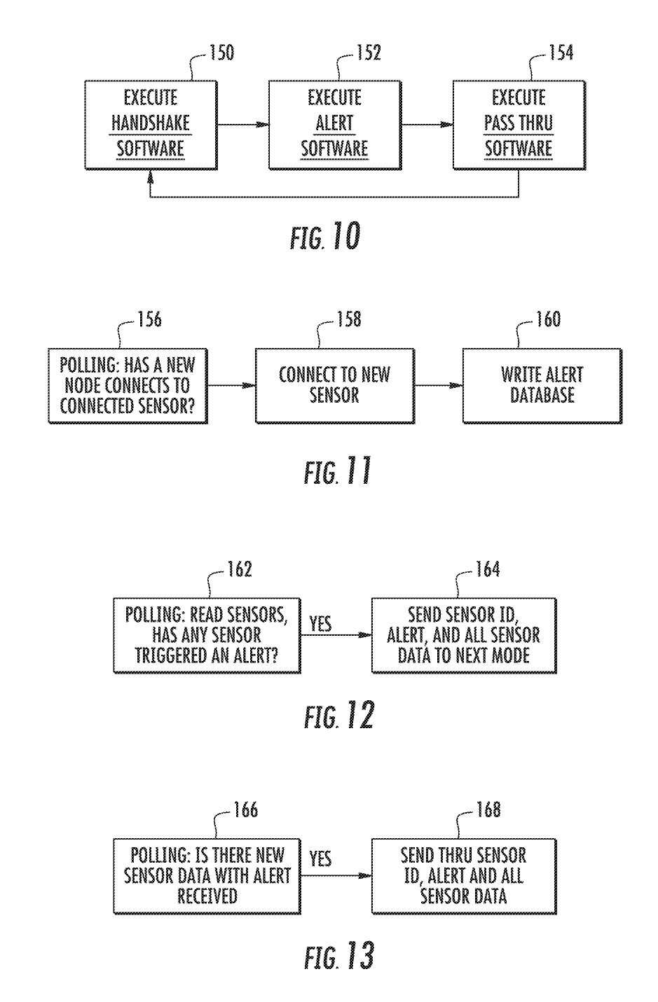

Referring to FIGS. 9 and 10, in operation the base software 140 generally oversees coordination of the handshake software, 146 the prioritization software 148 and the pass-thru software 144. The handshake software 146 of each detector 84 continuously handshakes (see block 150) other detectors to determine if a new detector has been added. If any one of the networked detectors 84 determines that a new detector is added, the networked detector 84 loads the alert database 142 to the memory 134 of the new/added detector. In block 152, the networked detectors 84 may then be continually checked by the alert prioritization software 148, and if an alert is found, send out an alert. In block 154, whether or not an alert is found, the pass-thru software 144 may be run to pass any connected detector 84 that may have an alert on. Eventually, the alerts make it to the cold chain mesh network gateway 78 back to the analysis module or cloud 80, and then to the reporting module 82 (i.e., monitoring terminal, also see FIG. 8).

Referring to FIG. 14, an example of an alert database 142 located in the computer readable medium 134 of each detector 84 is illustrated. The alert database 142 may generally contain sensor and product data for all detectors in a particular network. The alert database 142 may be populated through the handshake software 146. It is further contemplated and understood that the alert database 142 may be or may include a portion of the data table 90 previously described (see FIGS. 5 and 6) as being stored in the pre-programmed product information database 76 of the information coordination system 75.

Referring to FIGS. 9 and 11, in operation and when a new detector 84 is recognized by the networked detectors, the alert database 142 is downloaded to the new detector 84. This download may occur directly from one detector to the next and need not be downloaded, for example, through the analysis module 80 (e.g., cloud). More specifically, block 156 is the inquiry of whether a new detector is added to the networked detectors. If yes, block 158 is the connection or communication directly between a new detector and a networked detector. Then block 160 is the writing or downloading of the alert database 142 from the networked detector 84 to the added detector.

Referring to FIGS. 9 and 12, in operation and indicated in block 162, a networked detector 84 performs a self-check for any sensor triggered alerts. If an alert is triggered, then in block 164, the sensing detector 84 via transceiver 132 may send a detector/sensor identification and the sensed alert to other networked detectors 84.

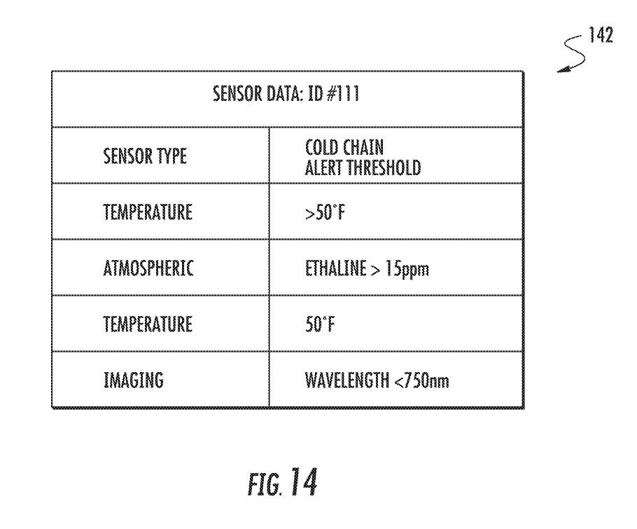

Referring to FIGS. 9 and 13, in operation and as indicated in block 166, the pass-thru software 144 facilitates a detector polling that generally inquires if there is new sensor data with a received alert. If yes, in block 168 the detector 84 which receives the alert (i.e., from another detector) passes the relevant sensor identification, alert and other sensor data (i.e., of the detector whose sensor(s) were triggered) through to the next detector and/or gateway. Once the alerts with the relevant detector/sensor identification reaches the gateway 78 and back to the monitoring terminal 82, the terminal 82 (or relevant servers or processors) may determine what actions need to be taken. In this way, the monitoring terminal 82 may manage or enable management of the cold chain detectors of many sub-disconnected networks.

Advantages and benefits of the present disclosure includes the utilization of the growing proliferation of detectors that have communication capacity in the cold chain supply line to create an ad hoc mesh network that prioritizes freshness data for transmittal. Real time monitoring data may be the standard priority until any perishable products 60 in the network begin to exhibit signs that they are progressing towards less than desirable retail condition. Data from the detectors 84 on those items may then receive a higher priority transmission. This higher priority may only be usurped if a threshold limit detector/sensor needs to send, for example, a freshness alarm/alert. Other advantages may include a means for shippers to monitor the condition of perishable products in transit. Moreover, the system may provide growers and sellers of perishable products, such as produce, with real time access to the condition of the produce in transit.

### Remote User Interface Capability

Referring to FIG. 8, the information coordination system 75 of the product condition system 74 may be configured to facilitate communication between a remote user and the environmental control assembly 36 of the cargo transport system 26 while, for example, on-route to a destination. In one example, the information coordination system 75 of the product condition system 74 may include a processor and computer readable and writeable storage medium that is separate from the control module 62 of the environmental control assembly 36, and instead, is configured to communicate with the control module 62 via, for example, the reporting module 82. The reporting module 82 may be an input/output device that receives and sends wireless signals to and from the control module 62 of the environmental control assembly 36. More specifically, at least a part of the information coordination system 75 may be a part of a remote server, or cloud server, configured for two-way communication directly with the condition detectors 84 and/or the control module 62 of the environmental control assembly 36. The analysis module 80 may be a remote, computer-based processor based on one or more microprocessors, microcontrollers, digital signal processors, baseband processors, power management units, audio codec chips, application specific integrated circuits, and others. The product information database 76 and the sensor database 78 of the information coordination system 75 may be a storage medium that includes at least one of a hard disk drive storage, nonvolatile memory (e.g., flash memory or other electrically-programmable-read-only memory configured to form a solid state drive), volatile memory (e.g., static or dynamic random-access-memory), and others.

The analysis module 80 may be used to run embedded and cloud server software such as internet browsing applications, voice-over-internet-protocol (VOIP) telephone call applications, email applications, media playback applications, operating system functions, and others. To support interactions with external equipment, the analysis module 80 may be used in implementing communications protocols. Such communication protocols may include internet protocols, and wireless local area network protocols (e.g. WiFi®), protocols for other short-range wireless communications links such as the Bluetooth® protocol, cellular telephone protocols, and others.

Referring to FIG. 15, the information coordination system 75 may further include a satellite navigation transmitter device 170 and user interface devices 172. The reporting module 82 that may be part of a cloud server may receive wireless signals from the satellite navigation transmitter device 170 associated with a position/location of, for example, the container 34. The reporting module 82 may be configured to receive and send wireless signals to and from the user interface device(s) 172, and send and receive wireless signals to and from the environmental control assembly 36. The user interface device 172 may be or include a computer monitor or screen (e.g., tablet, desktop and laptop) a cellular telephone, a media player (or other handheld or portable electronic device), a wrist-watch device, a pendant device, a headphone or ear-piece device, a router, an embedded system with electronic equipment and a display mounted to a kiosk or automobile, equipment that implements the functionality of two or more devices, and others.

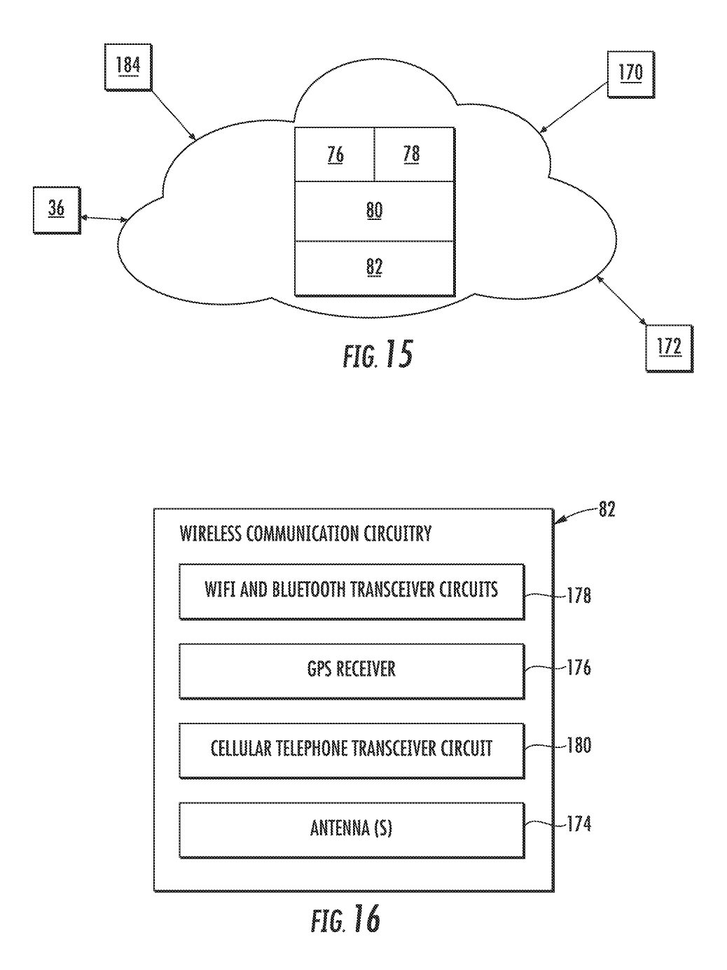

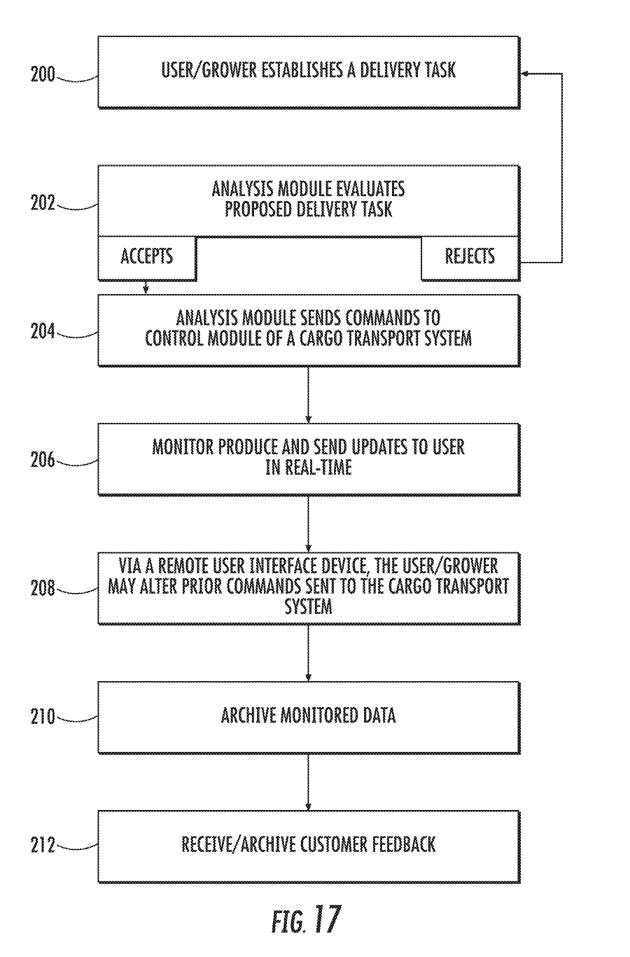

Referring to FIGS. 15 and 16, the reporting module 82 may be wireless communication circuitry that may include a radio-frequency (RF) transceiver circuit, a power amplifier circuit, low-noise input amplifiers, passive RF components, at least one antenna 174, and other components for receiving and broadcasting RF wireless signals (e.g., pathway 86). The reporting module 82 may further include a satellite navigation system receiver circuit 176, a wireless local area network transceiver circuit 178, a cellular telephone transceiver circuit 180, and others. The satellite navigation system receiver circuit 176 receives location signals from the satellite navigation transmitter device 170, and may be a Global Positioning System (GPS) receiver circuit, or circuitry associated with other satellite navigation systems. The wireless local area network transceiver circuit 178 may handle pre-specified frequency bands for WiFi® and/or Bluetooth® protocols. Although not illustrated, the wireless communication circuitry 178 may also include wireless circuits for receiving signals from radios, televisions, pagers, and others.

In addition to the product information database 76 and the sensor data database 78, the information coordination system 75 may include a destination information database 182 (see FIG. 3). The destination database 182 may include information related to an estimated time on-route, information relative to an end purchaser (e.g., historical information related to prior complaints/compliments, end purchaser ripeness preference, and other information), condition of product 60 when first loaded into the container 34, and other information. The analysis module 80 may utilize the destination information database 182 to further optimize product transport and product quality condition established at the time the product 60 reaches the prescribed destination. That is, the information coordination system 75 may facilitate: the evaluation of a ripening process during transport, treatments to the product while on-route to control the ripening process, planning of ripening (i.e., establishing a predictive ripening model), a virtual ripening planner and/or viewer for final customer levels, ripening testing, and feedback into the information coordination system 75 that may be used for future shipments.

Referring to FIG. 17 and in one example of operation, the product 60 may be a produce, and the person or user of the user interface device 172 may be a produce grower wanting to assure that his/her product is delivered to the customer efficiently and of the highest quality, and/or meeting customer expected condition and/or ripeness upon delivery. To accomplish this, in block 200 the user may establish a delivery task by entering into the user interface device 172: a produce type, an initial condition (e.g., ripeness condition) of the selected produce type, a desired delivery condition, and the location and/or identity of the customer. Alternatively, the desired delivery condition may be pre-stored in the destination database 182 and associated with a particular customer.

In Block 202 and using information provided by the destination database 182 and the produce information database 76, the analysis module 80 may then either confirm and accept the delivery task or reject the delivery task. The acceptance or rejection may be sent, for example, from a cloud server by the reporting module 82 and to the remote user interface device 172. Alternatively, the remote user interface device 172 may include a processor and storage medium that includes the analysis module 80 and at least the databases 76, 182. Through an execution of algorithm(s), the analysis module 80 may establish a rejection of a proposed delivery based on, for example, the inability to deliver the produce 60 in the condition (e.g., ripeness) that the customer wants. More specifically, the analysis module 80 is preprogrammed with the ability to determine various techniques of controlling the ripening of a given produce type with the given environmental control assembly 36 of the cargo transport system 26 over a given time period (e.g., duration of transport). In block 204, the analysis module 80, via the reporting module 82 may be configured to send commands to the control module 62 of the cargo transport system 26 to, for example, maintain a desired ripening rate of the produce 60.

In block 206, the information coordination system 75 may further be configured to update the user/grower of a current condition of the produce 60 in real-time during transport. Such an update is dependent upon the sensors 84 provided as part of the environmental control assembly and may include video capability. In block 208, the user via the remote user interface device 172 may have the ability to send commands to the analysis module 80 to control the ripening process based on the real-time updates. In block 210, the module 75 may also be configured to archive the data received by the sensor data database 78 for future reference. Such archived data may also be used to improve future produce deliveries. In block 212, the information coordination system 75 may also be configured to archive customer feedback that may, for example, include historical feedback about prior produce deliveries. Such feedback may be sent or inputted into the module 75 by, for example, a second remote user interface device 184 (e.g., cellular telephone) used by the customer (see FIG. 15).

### Computer and Communication Orientated Options

The present disclosure may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a Random Access Memory (RAM), a Read-Only Memory (ROM), an Erasable Programmable Read-Only Memory (EPROM or Flash Memory), a Static Random Access Memory (SRAM), a Portable Compact Disc Read-Only Memory (CD-ROM), a Digital Versatile Disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein may be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, Instruction-Set-Architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a Local Area Network (LAN) or a Wide Area Network (WAN), or the connection may be made to an external computer (for example, through the Internet using an Internet Service Provider). In some embodiments, electronic circuitry including, for example, programmable logic circuitry, Field-Programmable Gate Arrays (FPGA), or Programmable Logic Arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Benefits and advantages of the present disclosure include an objective assessment of actual perishable product condition over a time span during, for example, transportation. Other advantages include a real-time feedback to the Transport Refrigeration Unit (TRU), an intelligent manipulation of environmental parameters to optimize the condition of the perishable products upon arrival, minimize wear on the TRU, and optimizing energy efficiency. Yet further, because current conditions of the perishable product is known during transit, real-time technical, operational and commercial decision making can be achieved.

While the present disclosure is described with reference to illustrated embodiments, it will be understood by those skilled in the art that various changes may be made and equivalents may be substituted without departing from the spirit and scope of the present disclosure. In addition, various modifications may be applied to adapt the teachings of the present disclosure to particular situations, applications, and/or materials, without departing from the essential scope thereof. The present disclosure is thus not limited to the particular examples disclosed herein, but includes all embodiments falling within the scope of the appended claims.

What is claimed is:

1. A computer implemented method of operating an information coordination system of a cargo transport system comprising:
entering a proposed delivery task into a first remote user interface device;
monitoring a product for a specified condition utilizing an environmental control assembly of the cargo transport system; and
sending condition updates associated with the monitoring to the first remote user interface.

2. The computer implemented method set forth in claim 1 further comprising:
evaluating the proposed delivery task by an analysis module for acceptance or rejection.

3. The computer implemented method set forth in claim 2, wherein at least one of product type data, customer data, time in transport data, initial product condition data and arriving product condition data is applied to evaluate the proposed delivery task.

4. The computer implemented method set forth in claim 1 further comprising:
controlling the environmental control assembly via the first remote user interface device.

5. The computer implemented method set forth in claim 1 further comprising:
archiving the monitored product condition data by the information coordination system.

6. The computer implemented method set forth in claim 1 further comprising:
inputting customer feedback data into a database via a second remote user interface device.

7. An information coordination system of a cargo transport system comprising:
an analysis module configured to communicate with the cargo transport system;
a first remote user interface configured to communicate with the analysis module; and
a destination database configured to receive destination data from the first remote user interface and provide the data to the analysis module for execution.

8. The information coordination system set forth in claim 7, wherein the data includes a product destination.

9. The information coordination system set forth in claim 8 further comprising:
a sensor data database configured to receive sensor data from the cargo transport system; and
a reporting module configured to communicate with the first remote user interface for providing at least a product condition update of a product in transport and associated with the sensor data.

10. The information coordination system set forth in claim 9 further comprising:
a second remote user interface configured to send customer feedback data to the reporting module.

11. The information coordination system set forth in claim 10, wherein the customer feedback data is stored in the destination database.

12. The information coordination system set forth in claim 9, wherein the analysis module is configured to execute an algorithm utilizing at least the destination data and the sensor data to determine a predicted product condition upon arrival.

13. The information coordination system set forth in claim 12, wherein the destination data includes a destination and a desired product condition upon arrival.

14. The information coordination system set forth in claim 13, wherein the product is produce and the product condition is ripeness.

15. The information coordination system set forth in claim 14, wherein the product condition is best fit for market consumption.

16. The information coordination system set forth in claim 13, wherein the destination data includes an initial condition.

17. The information coordination system set forth in claim 13, wherein the desired product condition is associated with a specific customer stored as data in the destination database.

18. The information coordination system set forth in claim 12, wherein the analysis module is configured to output a command signal to the cargo transport system to control the product condition.

19. The information coordination system set forth in claim 1, wherein the first remote user interface is wireless.

20. The information coordination system set forth in claim 18, wherein the analysis module includes a satellite navigation system receiver circuit for determining current location of the product during transport.
